(19) United States
(12) Patent Application Publication
(10) Pub. No.: US 2026/0027811 A1
(43) Pub. Date: Jan. 29, 2026

(54) FACER FOR POLYISOCYANURATE INSULATION BLOCK

(71) Applicant: CARLISLE CONSTRUCTION MATERIALS, LLC, Carlisle, PA (US)

(72) Inventor: Phuong Minh Nguyen DO, Newark, DE (US)

(73) Assignee: CARLISLE CONSTRUCTION MATERIALS, LLC, Carlisle, PA (US)

(21) Appl. No.: 19/276,977

(22) Filed: Jul. 22, 2025

Related U.S. Application Data
(60) Provisional application No. 63/676,816, filed on Jul. 29, 2024.
(60) Provisional application No. 63/676,824, filed on Jul. 29, 2024.

(51) Int. Cl. B32B 23/04; B32B 5/24; B32B 23/10; B32B 37/15

(52) U.S. Cl. CPC B32B 23/048; B32B 5/245; B32B 23/10; B32B 37/15; B32B 2250/03; B32B 2305/022; B32B 2305/72; B32B 2307/70; B32B 2317/18; B32B 2375/00

(57) ABSTRACT

A polyisocyanurate insulation block assembly, including: (a) a foamed block of polyisocyanurate insulation; (b) a bottom facer underneath the foamed block of polyisocyanurate insulation; and (c) a top facer on top of the foamed block of polyisocyanurate insulation, wherein the top facer comprises an amorphous high performance plastic or a vulcanized fiber.

### RELATED APPLICATIONS

The present application claims priority both to U.S. Provisional Patent Application Ser. No. 63/676,816, entitled Vulcanized Fiber Facer for Polyisocyanurate Insulation Block, filed Jul. 29, 2024, and to U.S. Provisional Patent Application Ser. No. 63/676,824, entitled Amorphous High Performance Plastic Facer for Polyisocyanurate Insulation Block, filed Jul. 29, 2024, the entire disclosures of which are incorporated herein by reference in their entireties for all purposes.

### TECHNICAL FIELD

The present invention relates to facers for polyisocyanurate insulation blocks.

### BACKGROUND OF THE INVENTION

Polyisocyanurate (“polyiso”) insulation blocks for building roof insulation are typically made in a continuous online manufacturing process. In this process, top and bottom facers are unwound from large rolls on the laminating machine while the polyiso is applied as a foam between these two facers. As such, the polyiso foam is poured onto the bottom facer while the top facer is applied over the top of the polyiso foam. The polyiso foam bonds to both the top and bottom facers and the resulting product is produced as a three-layer insulation block assembly. Next, during the manufacturing process, the three-layer assembly is cut into the large flat blocks which are the final “insulation blocks” that are to be placed onto the roof of a building.

The polyiso foam in the middle of this assembly gives the insulation block its insulating properties. The top and bottom facers both give the insulation board its mechanical shape and structure and are the surfaces handled by roofing installers when they secure these insulation boards onto the roof. Most importantly, the top and bottom facers form the top and bottom of the polyiso insulation block and protect the comparatively fragile foam insulation from damage.

Typically, polyiso facers are made from one of three materials, being: glass reinforced felt facers (GRFs), coated glass facers (CGFs) or aluminum foil facers (AFFs). GRF facers make up about 85% of the building market. They are the cheapest facers to manufacture. Unfortunately, they have poor wind uplift performance (due to their shorter (non-virgin) cellulose fibers). They also have the worst moisture and mold resistance despite additional chemical treatment of available facers, and also tend to have the worst fire performance. The more superior CGF captures the remaining 15% of the market. Although more expensive than GRF, CGF has better moisture and fire performance coupled with better dimensional stability. Unfortunately, CGF have the drawback of a potential supply chain risk. This is because they compete for nonwoven glass mat materials which are instead typically sold to asphalt shingle manufacturers.

All of the above facers have the limitation of being somewhat fragile and are prone to puncture and damage after installation (as well as during tear off). In addition, if the polyiso insulation blocks are attached to the roof surface with mechanical fasteners, any overdriving of the screws can damage both the facer and the polyiso boards.

Another problem with current facers are that they contain additives such as fiberglass and coatings. Some of these coatings can act as skin, eye and upper respiratory tract irritants. Finally, glass reinforced facer can produce corrosive smoke if burned during a fire. For these reasons, it would instead be desirable to design facers that have less environmental downsides.

To further protect polyiso insulation blocks during installation, coverboards are often installed over the top surfaces of the polyiso insulation blocks. These coverboards can be made of different materials including gypsum, engineered composites of plastic and cellulose fiber, and high density polyiso. Coverboards are often desired to protect the polyiso insulation blocks from damage by roofing installers walking over the polyiso insulation boards.

It would instead be desirable to avoid the extra costs of building and installing these coverboards. What would instead be desired is a polyiso insulation board having a top facer that is itself sufficiently strong and resilient that the facer alone provides sufficient protection for the polyiso insulation board. As will be shown, the present system provides such a strong and protective top (and optional bottom) facer.

### SUMMARY OF THE INVENTION

The present invention uses an amorphous high performance plastic such as polyphenylsulfone (PPSU), polyetherimide (PEI), polyethersulfone (PES) or polysulfone (PSU) or a vulcanized fiber as a novel top facer material (and optionally bottom facer material as well) for a block of polyisocyanurate foam insulation. In preferred aspects, the present system provides a polyisocyanurate insulation block assembly, comprising:
a foamed block of polyisocyanurate insulation;
a bottom facer underneath the foamed block of polyisocyanurate insulation; and
a top facer on top of the foamed block of polyisocyanurate insulation, wherein the top facer comprises an amorphous high performance plastic or a vulcanized fiber.

When an amorphous high performance plastic is used, the amorphous high performance plastic material can be polyphenylsulfone (PPSU), polyetherimide (PEI), Polyethersulfone (PES) or Polysulfone (PSU).

Polyphenylsulfone is an amorphous, highly heat-resistant, inherently flame-retardant, and naturally transparent high-performance thermoplastic. It was first introduced under the trade name Udel by Union Carbide in 1965. It can be produced by the reaction of p-dichlorobenzene with sodium sulfide in a polar solvent. It can also be formed by the polymerization of p-halothiophenoxide metal compounds both in the solid state and in solution, or via the condensation of p-dichlorobenzene with elemental sulfur in the presence of sodium bicarbonate.

Polyphenylsulfone exhibits high toughness, outstanding flexural and tensile strengths, excellent hydrolytic stability and good resistance to heat. It is also resistant to chemicals including aqueous mineral acids, bases, and oxidizing agents and most solvents. Polyphenylsulfone also has better impact resistance and chemical resistance than polyetherimide (PEI). One advantage of using a polyphenylsulfone facer is that the facer has strong mechanical properties including high strength and stiffness. Therefore, the advantage of polyphenylsulfone facers are that its extra toughness can protect the foam insulation it covers and thereby eliminate the need for a coverboard over the insulation blocks. Polyphenylsulfone facers are also hard to break down and are impervious to most oil and petroleum derivatives in addition to alcohol and ammonia. In addition to being able to withstand the effects of roofers walking on the roof, it is also necessary that polyiso roofing insulation withstand the weight of roof-installed solar power systems. Polyphenylsulfone facers on polyiso insulation boards would meet this challenge.

Polyphenylsulfone facers have other advantages as well. For example, their electrical resistance protects building roofs from electrical incidents such as fires caused by roof-mounted solar power systems. In addition, their chemical resistance to oil and petroleum derivatives is that it may help protect flammable insulation from quickly spreading fires. Polyiso insulation contains some ammonia that it is used as a catalyst during its formation. Unfortunately, the ammonia in the foam is slowly released over time (passing through current facers). An advantage of the present embodiment of using a polyphenylsulphone facer is that it is impervious to ammonia (or less permeable to ammonia than traditional facers). As a result, a polyphenylsulphone facer has a low vapor permeance which can help in preventing the ammonia gas from escaping into the atmosphere. The polyiso may also contain pentanes which can be stopped by a polyphenylsulphone facer.

Polyetherimide was first introduced in 1982 by General Electric Company under the Tradename ULTEM®. It is a high-performance engineering thermoplastic. Polyetherimide is based on the repeating units of ether and imide linkages. The aromatic imide units provide the high-performance properties while the flexible ether linkages allow for good melt flow characteristics and easy processability. Polyetherimide is considered an advanced thermoplastic which has both ether links and imide groups in its polymer chain. Polyetherimide is also an amorphous high-performance polymer which is characterized by excellent thermal properties, good chemical resistance, inherent flame retardancy, and exceptional dimensional stability. Polyetherimide also exhibits high tensile strength, without the use of reinforcement, very low smoke emission, and excellent hydrolytic stability. Because of polyetherimide's high stability, its range of processing is wider than many other thermoplastics. Another advantage of using a polyetherimide facer is that the facer has strong mechanical properties including high strength and stiffness. Therefore, the advantage of polyetherimide facers are that their extra toughness can protect the foam insulation it covers and thereby eliminate the need for a coverboard over the insulation blocks. Polyetherimide facers are also hard to break down and are impervious to most oil and petroleum derivatives in addition to alcohol and ammonia. In addition to being able to withstand the effects of roofers walking on the roof, it is also necessary that polyiso roofing insulation withstand the weight of roof-installed solar power systems. Polyetherimide facers on polyiso insulation boards and vulcanized facers on polyiso insulation boards would meet this challenge.

Polyetherimide facers have other advantages as well. For example, its electrical resistance protects building roofs from electrical incidents such as fires caused by roof-mounted solar power systems. In addition, its chemical resistance to oil and petroleum derivatives is that it may help protect flammable insulation from quickly spreading fires. Polyiso insulation contains some ammonia that it is used as a catalyst during its formation. Unfortunately, the ammonia in the foam is slowly released over time (passing through current facers). An advantage of the present embodiment of using a polyetherimide facer or vulcanized fiber facer is that it is impervious to ammonia. As a result, a polyetherimide facer has a low vapor permeance which can help in preventing the ammonia gas from escaping into the atmosphere. The polyiso may also contain pentanes which can be stopped by a polyetherimide facer.

Polyethersulfone (PES) or Polysulfone (PSU) are expected to display the same advantages as polyphenylsulfone (PPSU), polyetherimide (PEI), discussed above.

In other preferred embodiments, the facer is made of vulcanized fiber. In preferred embodiments, the vulcanized fiber is prepared by heating layers of cellulose materials and may be prepared by: adding zinc chloride to cellulose materials to produce a slurry; then flattening the slurry into thin sheets; and then finally laminating the thin sheets together under heat and pressure to form the vulcanized fiber. As such, the present system also provides a method of making a polyisocyanurate insulation block assembly by foaming polyisocyanurate insulation between top and bottom facers, wherein the top, or top and bottom facers comprise vulcanized fiber.

One advantage of using a vulcanized fiber facer is that the facer is made of cellulose. As such, it is an environmentally friendly material. Being an environmentally friendly material, it can easily be recycled. Other beneficial properties of using a vulcanized fiber facer include the fact that it: (1) has a high tensile and tear strength; (2) has good electrical resistance; and (3) is impervious to most oil and petroleum derivatives in addition to alcohol and ammonia. Advantageously as well, vulcanized fibers can be made to be tougher than leather, stiffer than most thermoplastics and lighter than aluminum. As such, vulcanized fiber facers can be made to be more resilient than current polyiso facers. Therefore, another advantage of vulcanized fiber facers are that their extra toughness can protect the foam insulation it covers and thereby eliminates the need for a coverboard over the insulation blocks. Vulcanized fiber facers have other advantages as well. For example, their electrical resistance protects building roofs from electrical incidents such as fires caused by roof-mounted solar power systems. In addition, their chemical resistance to oil and petroleum derivatives is that it may help protect flammable insulation from quickly spreading fires. In experiments performed by the present inventors, the burning of vulcanized fibers facer on a polyiso foam did not release corrosive gasses.

### BRIEF DESCRIPTION OF THE DRAWINGS

FIG. 1 is a sectional side elevation view of the present polyisocyanurate insulation block assembly.

FIG. 2 is an illustration of the present method of making the present polyisocyanurate insulation block assembly.

### DETAILED DESCRIPTION OF THE DRAWINGS

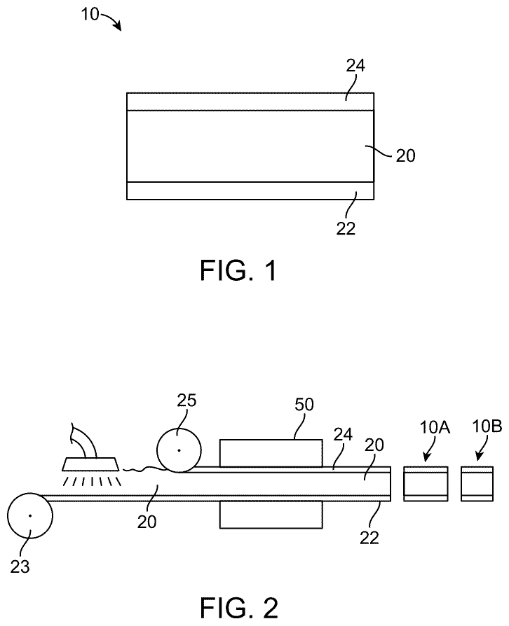

FIG. 1 is a sectional side elevation view of the present polyisocyanurate insulation block assembly 10, comprising: a foamed block 20 of polyisocyanurate insulation; a bottom facer 22 underneath the foamed block 20 of polyisocyanurate insulation; and a top facer 24 on top of the foamed block 20 of polyisocyanurate insulation. In accordance with the present invention, the top facer 24 comprises vulcanized fiber or polyphenylsulfone (PPSU), polyetherimide (PEI), polyethersulfone (PES) or polysulfone (PSU), or other suitable amorphous high performance plastic.

In one embodiment, vulcanized fiber is used. Vulcanized fibre is a low-pressure laminated plastic compound composed purely of cellulose. It is one of the oldest plastics with its earliest form dating back to 1879. It can be prepared by heating layers of cellulose materials. For example, vulcanized fiber 24 is prepared by: adding zinc chloride to cellulose materials to produce a slurry; and then flattening the slurry into thin sheets (typically under heat or steam by hydraulic presses or rolls); and then laminating the thin sheets together under heat and pressure to form the vulcanized fiber. Vulcanized fiber can be machined in much the same way as other plastics. It can easily be formed, bent, sawed, sheared, punched, milled, turned, and drilled.

It is contemplated that different types of vulcanized fibers may be used for top facer 24 (and optionally bottom facer 22 as well). For example, vulcanized fiber is supplied in many different grades, including: (1) Commercial-Grade Fiber which is tough and resilient; (2) Electrical-Grade Fiber; (3) Trunk Fiber which is exceptionally hard and abrasion-resistant; and (4) Bone Fiber which has extreme density and is the hardest vulcanized fiber available.

Vulcanized fiber facers offer a broad array of benefits compared to traditional facers, including: (1) being Eco-Friendly since it is almost entirely composed of cellulose and does not include artificial binding agents. Compared to other plastics, the manufacturing process is more environmentally friendly and exposes consumers to fewer chemicals; (2) being Highly Versatile as it can be formulated for a variety of applications; (3) having Mechanical Benefits since it exhibits a high strength-to-weight ratio and is exceptionally machinable. It typically will not break, tear, or splinter during processing; (4) having Chemical Resistance being able to withstand exposure to a variety of chemical solvents, oils, and grease without deteriorating; and (5) being Cost-Effective as relatively inexpensive to manufacture and can be customized at minimal cost to enhance desired characteristics.

Similarly, amorphous high performance plastic facers offers a broad array of benefits compared to traditional facers, including: (1) high strength and rigidity; (2) high heat and flame resistance; and (3) good electrical resistance. They are mechanically stable under extreme conditions, having a high strength-to-weight ratio, rigidity, flexibility and dimensional strength.

In terms of flame resistance, amorphous high performance plastics such as polyphenylsulfone have been experimentally determined by the present inventor to slow fire spreading in polyiso insulation. Specifically, when the present inventors used both top and bottom facers made of polyphenylsulfone, the bottom facer was not burnt through under a cone calorimetry test performed according to ASTM E1354-23. Therefore, polyphenylsulfone is inherently flame resistant without requiring flame retardant additives. In terms of flame resistance, polyetherimide has a high limiting oxygen index of 47 (as compared to only 17 of polypropylene and 20 to 40 for plasticized PVC). Therefore, polyetherimide is inherently flame resistant without requiring flame retardant additives.

In optional embodiments, the bottom facer 22 may also comprise vulcanized fiber or an amorphous high performance plastic. An advantage of having both top and bottom facers 24 and 22 both made of the same material is that the top and bottom facers will have the same thermal expansion characteristics.

FIG. 2 is an illustration of the present method of making the present polyisocyanurate insulation block assembly. Explained simply, polyiso foam 20 is applied as a foam directly on top of bottom facer 22 (which is unrolled from roll 23). Next, top facer 24 is unrolled from roll 25. The foam 20 and facers 22 and 24 pass together through laminating machine 50 where the foam adheres to facers 22 and 24. Finally, the insulation board leaves the process and is cut into separate blocks 10A and 10B, etc. for installation on a building roof.

### Experimental Results:

In a first test, the present inventors manufactured a two inch polyiso board with a 20 mil polyphenylsulfone film facer. Static puncture testing according to ASTM D5602 showed the PPSU facer material not punctured after 72 hours at 64.5 lbs weight on 0.1″ point load. Current 0.5″ high density polyiso coverboard failed this test after 24 hours at 25 lbs. Furthermore, the present PPSU facer sample maxed out 0.5 ton-force (1,179 lbf) load cell in the static geo puncture test according to EN 12236. In contrast, the half inch high density polyiso coverboard had 333 lbf maximum compressive load.

In a second test, the present inventors manufactured a two-inch polyiso sample made with 10-mil polyetherimide facers 24. The sample underwent a static puncture test according to ASTM D5602 and the facer not punctured after 24 hours at 45 lbs weight on 0.1″ point load. In contrast, current 0.5″ high density polyiso coverboard failed this test after 24 hours at 25 lbs. Furthermore, the polyetherimide sample had a maximum compressive load of 129 lbf in geo puncture test (ASTM D4833), more than two times higher than that of high density polyiso coverboard (51 lbf).

What is claimed is:

1. A polyisocyanurate insulation block assembly, comprising:
a foamed block of polyisocyanurate insulation;
a bottom facer underneath the foamed block of polyisocyanurate insulation; and
a top facer on top of the foamed block of polyisocyanurate insulation, wherein the top facer comprises an amorphous high performance plastic or a vulcanized fiber.

2. The assembly of claim 1, wherein the top facer comprises an amorphous high performance plastic made of polyphenylsulfone.

3. The assembly of claim 1, wherein the top facer comprises an amorphous high performance plastic made of polyetherimide.

4. The assembly of claim 1, wherein the top facer comprises an amorphous high performance plastic made of polyethersulfone.

5. The assembly of claim 1, wherein the top facer comprises an amorphous high performance plastic made of polysulfone.

6. The assembly of claim 1, wherein the bottom facer comprises polyphenylsulphone.

7. The assembly of claim 1, wherein the top facer comprises vulcanized fiber.

8. The assembly of claim 7, wherein the vulcanized fiber is prepared by heating layers of cellulose materials.

9. The assembly of claim 7, wherein the vulcanized fiber is prepared by:
adding zinc chloride to cellulose materials to produce a slurry; and then
flattening the slurry into thin sheets; and then
laminating the thin sheets together under heat and pressure to form the vulcanized fiber.

10. The assembly of claim 7, wherein the bottom facer comprises vulcanized fiber.

11. A method of making a polyisocyanurate insulation block assembly, comprising:
foaming polyisocyanurate insulation between top and bottom facers, wherein the top facer comprises an amorphous high performance plastic or a vulcanized fiber.

12. The method of claim 11, wherein the vulcanized fiber is prepared by:
adding zinc chloride to cellulose materials to produce a slurry; and then
flattening the slurry into thin sheets; and then
laminating the thin sheets together under heat and pressure to form the vulcanized fiber.

13. The method of claim 11, wherein the bottom facer comprises an amorphous high performance plastic or a vulcanized fiber.
